(19) United States
(12) Patent Application Publication
(10) Pub. No.: US 2010/0157884 A1
(43) Pub. Date: Jun. 24, 2010

(54) BASE STATION DEVICE AND MOBILE STATION DEVICE

(75) Inventors: Hiroki Haga, Kanagawa (JP); Hidenori Matsuo, Kanagawa (JP); Katsuyoshi Naka, Kanagawa (JP); Katsuhiko Hiramatsu, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 11/997,713

(22) PCT Filed: Aug. 4, 2005
(86) PCT No.: PCT/JP2005/014318

§ 371 Date: Feb. 1, 2008

(51) Int. Cl. H04W 40/00; H04L 27/28

(52) U.S. Cl. 370/328; 375/260

(57) ABSTRACT

A base station device and a mobile station device both enabling improvement of the reception quality of transmission data at a mobile station by preventing a sequence for establishing synchronism and the transmission data from interfering with each other. In the base station device (100), a frame creating section (120) creates a frame in such a way that the transmission data and the sequence used for identifying the frame timing and the code group to which the base station scrambling code belongs are so arranged that they are not superposed on one the other at the same symbol specified by the sub-carrier and time, and an RF transmitting section (150) transmits the frame. In the mobile station device (200), an RF receiving section (210) receives the frame from the base station device (100), an SCH correlation calculating section (240) calculates the correlation by multiplying all the candidates of the sequence by the frame one by one, and a frame timing/code group detecting section (250) detects the frame timing and the code group by using the correlation value acquired from the SCH acquired from the SCH correlation value calculating section (240).

### TECHNICAL FIELD

The present invention relates to a base station apparatus and a mobile station apparatus. More particularly, the present invention relates to a base station apparatus and a mobile station apparatus that performs a cell search based on a frame transmitted from the base station apparatus.

### BACKGROUND ART

In a multicarrier communication system, scramble codes different for each cell are allocated to identify cells to be covered by the base station apparatus, and the mobile station apparatus needs to perform a cell search upon switching of cells (handover) associated with move or upon discontinuous reception (DRX), that is, needs to identify scramble codes to identify the cells. As a method of cell search, three-step cell search is well known (for example, see Non-Patent Document 1).

The three-step cell search is performed in order of symbol timing detection (first step), scramble code group identification and scramble code timing detection, that is, frame timing detection (second step), and scramble code identification (third step).

FIG. 17 shows the frame configuration in the conventional three-step cell search. In FIG. 17, the horizontal axis shows time, the vertical axis shows power, and the perspective axis shows frequency. As shown in FIG. 17, SCHs (Synchronization Channels) that are consecutive in the time domain are multiplexed over subcarriers of equal intervals in the frequency domain. These SCHs are utilized as a sequence for acquiring synchronization at the receiving side. Further, SCHs having a common symbol sequence pattern are allocated to subcarriers in the same cell. Each step will be described below.

In the first step, the mobile station apparatus detects a symbol timing (that is, an FFT (Fast Fourier Transform) window timing) by utilizing correlation characteristics of the OFDM guard interval.

In the second step, a frame timing is detected by utilizing the SCHs. That is, the mobile station apparatus performs FFT processing on the received data signals, demultiplexer the subcarriers where the SCHs are multiplexed, and calculates the time domain correlation between the received data signal after FFT processing and an SCH sequence replica per subcarrier. The mobile station apparatus performs power addition of the calculated correlation values between subcarriers and detects a timing at which the greatest correlation value is calculated as a frame timing. In this case, by preparing a plurality of SCH sequences and making a code group associated with each of the SCH sequences, the mobile station apparatus can perform code group identification and frame timing detection at the same time. To be more specific, the mobile station apparatus calculates the time domain correlation between replicas of the plurality of SCH sequences and the received data signals after FFT processing per subcarrier. The mobile station apparatus performs power addition of the calculated correlation values between subcarriers per SCH sequence and identifies the code group corresponding to the SCH sequence for which the greatest correlation value is calculated. In this way, in the second step, frame timing detection and code group identification are performed. In the third step, the time-multiplexed CPICH (Common Pilot Channel) is extracted from the frame timing detected in the second step. Replicas of CPICHs corresponding to all scramble codes that belong to the code group identified in the second step are generated. The mobile station apparatus calculates the correlation between the generated CPICH replicas and the extracted CPICH and identifies the scramble code corresponding to the greatest correlation value as a scramble code for the cell.

Non-Patent Document 1: Yukiko Hanada, Hiroyuki Atarashi, Kenichi Higuchi and Mamoru Sawahashi (NTT DoCoMo, Inc.) RCS2001-091 (2001-07), “3-Step Cell Search Performance using frequency-multiplexed SCH for Broadband Multi-carrier CDMA Wireless Access”

### DISCLOSURE OF INVENTION

### Problems to be Solved by the Invention

However, with the conventional cell search method in multicarrier CDMA, SCHs are additionally transmitted with TCHs (Traffic Channels), that is, transmission data, and therefore received quality of TCHs may deteriorate at the receiving side due to interference of the SCHs against the TCHs.

It is therefore an object of the present invention to provide a base station apparatus and a mobile station apparatus that perform multicarrier communication, prevent interference between a sequence for acquiring synchronization and transmission data, and improve received quality of transmission data at the mobile station.

### Means for Solving the Problem

The base station apparatus of the present invention performs multicarrier transmission and adopts a configuration including: a frame forming section that forms a frame by mapping transmission data and a sequence used to identify a frame timing and a code group to which a base station scrambling code belongs at the receiving side, such that the transmission data and the sequence do net overlap with each other in the same symbols specified by subcarriers and time; and a transmitting section that transmits the formed frame.

The mobile station apparatus of the present invention performs a cell search based on a frame transmitted from the base station apparatus and adopts a configuration including: a receiving section that receives a frame where transmission data and a sequence are mapped such that the transmission data and the sequence do not overlap with each other in the same symbols specified by subcarriers and time, the sequence being used to identify a frame timing and a code group to which a base station scrambling code belongs; a correlating section that calculates correlations by sequentially multiplying the frame by all candidates of the sequence; and a detecting section that detects the frame timing and the code group based on the correlation values calculated by the correlating section.

### ADVANTAGEOUS EFFECT OF THE INVENTION

According to the present invention, it is possible to provide a base station apparatus and a mobile station apparatus that perform multicarrier communication, prevent interference between a sequence for acquiring synchronization and transmission data, and improve received quality of transmission data at the mobile station.

### BRIEF DESCRIPTION OF DRAWINGS

FIG. 1 is a block diagram showing a configuration of a base station apparatus according to Embodiment 1 of the present invention;

FIG. 2 shows an example of a configuration of a frame transmitted by the base station apparatus in FIG. 1;

FIG. 3 is a block diagram showing a configuration of a mobile station apparatus according to Embodiment 1;

FIG. 4 shows another example of the configuration of the frame transmitted by the base station apparatus in FIG. 1;

FIG. 5 is a block diagram showing a configuration of a base station apparatus according to Embodiment 2;

FIG. 6 shows an example of a configuration of a frame transmitted by the base station apparatus in FIG. 5;

FIG. 7 is a block diagram showing a configuration of a mobile station apparatus according to Embodiment 2;

FIG. 8 shows another example of the configuration of the frame transmitted by the base station apparatus in FIG. 5;

FIG. 9 is a block diagram showing a configuration of a base station apparatus according to Embodiment 3;

FIG. 10 shows an example of a configuration of a frame transmitted by the base station apparatus in FIG. 9;

FIG. 11 is a block diagram showing a configuration of a mobile station apparatus according to Embodiment 3;

FIG. 12 shows another example of the configuration of the frame transmitted by the base station apparatus in FIG. 9;

FIG. 13 is a block diagram showing a configuration of a base station apparatus according to Embodiment 4;

FIG. 14 shows an example of a configuration of a frame transmitted by the base station apparatus in FIG. 13;

FIG. 15 is a block diagram showing a mobile station apparatus according to Embodiment 4;

FIG. 16 is another example of the configuration of the frame transmitted by the base station apparatus in FIG. 13; and

FIG. 17 shows a frame configuration in conventional three-step cell search.

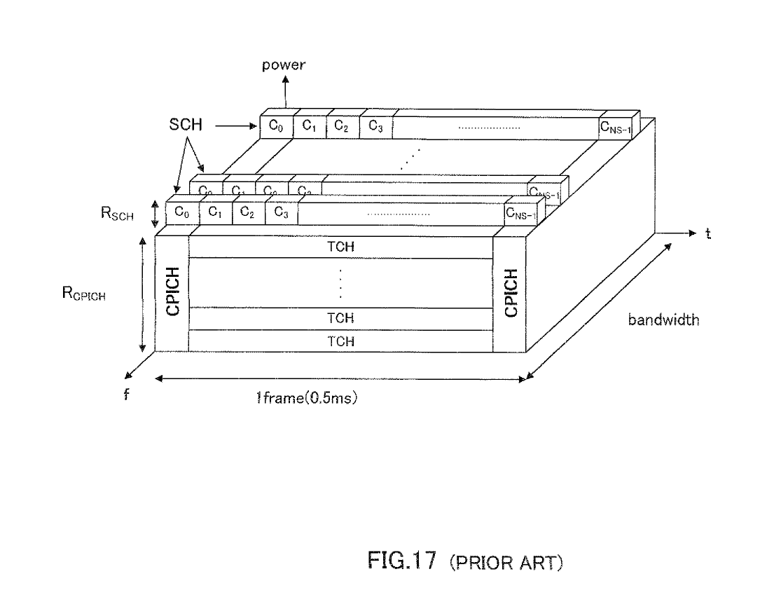

### BEST MODE FOR CARRYING OUT THE INVENTION

Embodiments of the present invention will be described in detail below with reference to the accompanying drawings. In the embodiments, the same components are assigned the same reference numerals without further explanations.

### Embodiment 1

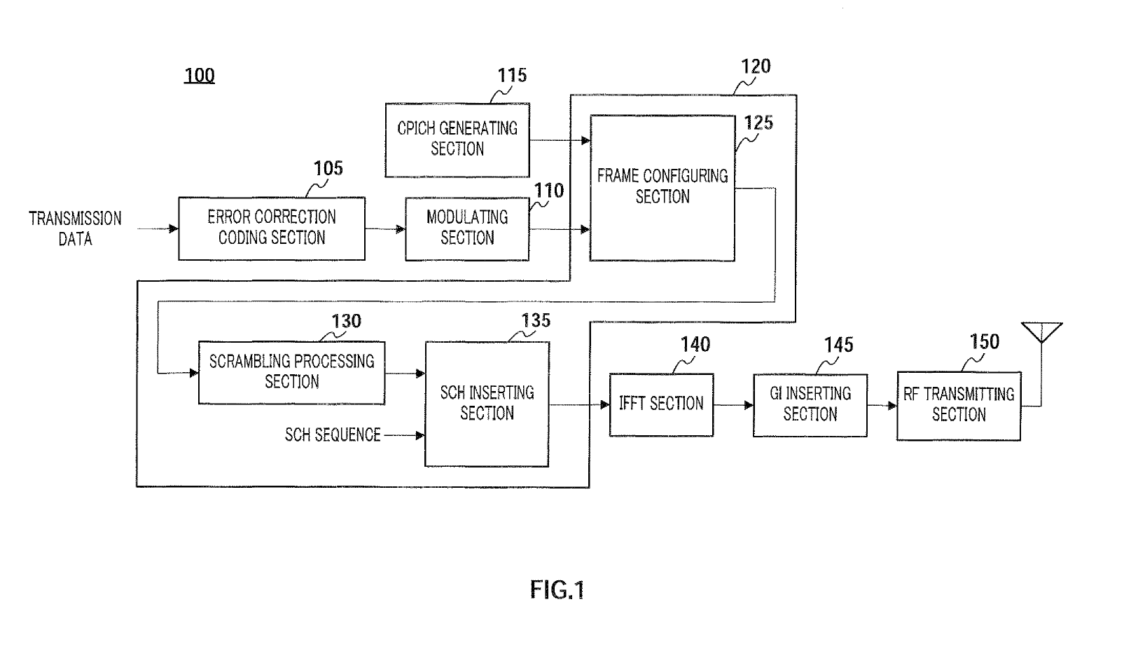

As shown in FIG. 1, base station apparatus 100 of Embodiment 1 has error correction coding section 105, modulating section 110, CPICH generating section 115, frame forming section 120, IFFT section 140, GI inserting section 145 and RF transmitting section 150. Frame forming section 120 has frame configuring section 125, scrambling processing section 130 and SCH inserting section 135.

Error correction coding section 105 receives transmission data and performs predetermined error correction coding processing. Modulating section 110 receives a signal after error correction coding and performs predetermined modulating processing. CPICH generating section 115 generates a CPICH symbol.

Frame configuring section 125 receives and maps the CPICH symbol and the modulated signal at predetermined positions in the frequency domain and the time domain taking into consideration the position in the frame where the SCH sequence is inserted by SCH inserting section 135. The frame configured in this way by frame configuring section 125 is inputted to scrambling processing section 130.

Scrambling processing section 130 multiplies the frame formed by frame configuring section 125 by a base station scrambling code which is unique to base station apparatus 100. This base station scrambling code is used to identify the cell (or sectors) covered by base station apparatus 100.

SCH inserting section 135 inserts an SCH sequence as a synchronization code to the frame multiplied by the base station scrambling code at scrambling processing section 130. In this embodiment, the SCH sequence is frequency-multiplexed over a plurality of predetermined subcarriers, that is, predetermined positions in the frequency domain, and the frequency-multiplexed SCH sequence is inserted to the frame after scrambling processing. A code group sequence, which is a code group that groups base station scrambling codes, is used as the SCH sequence. Further, the length of the SCH sequence corresponds to the length of one frame, and the SCH sequence is mapped in synchronization with the frame timing.

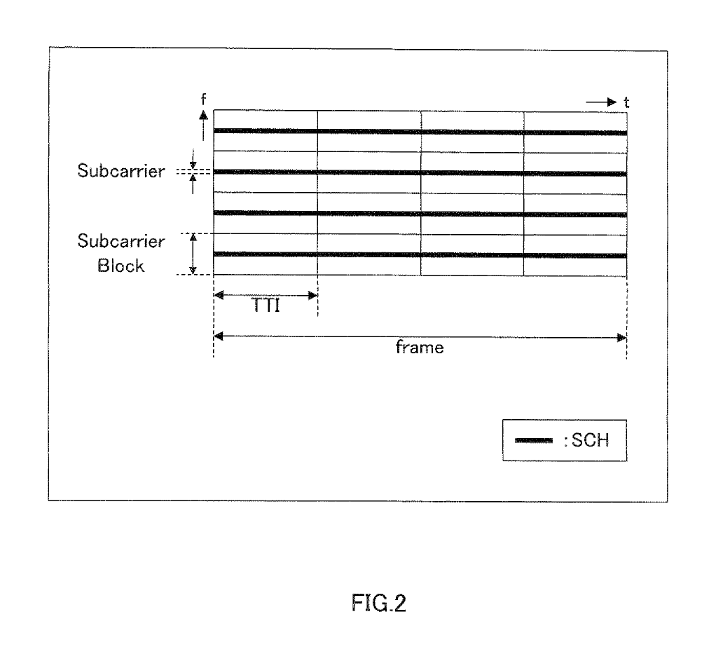

The frame formed as described above by frame forming section 120 adopts the configuration shown in FIG. 2. That is, in this frame configuration, the SCH sequence is mapped on a plurality of predetermined subcarriers in the time domain, a TCH (Traffic CHannel) is mapped on other subcarriers, and the SCH sequence and the TCH sequence do not overlap with each other in the frequency domain. By adopting such a frame configuration, interference between the SCH sequence and the TCH sequence can be prevented, so that it is possible to improve received quality of the TCH in this frame at the receiving side.

IFFT section 140 performs an inverse fast Fourier transform (IFFT) on the frame (transmission signal) where the SCH sequence is inserted by SCH inserting section 135 to convert the frame from the frequency domain to the time domain, and outputs the result to GI inserting section 145.

GI inserting section 145 inserts a guard interval (GI) to the output signal of IFFT section 140. The guard interval is inserted on a per OFDM symbol basis.

The signal to which the guard interval is inserted is subjected to RF processing such as up-conversion and A/D conversion by RF transmitting section 150 and transmitted via an antenna.

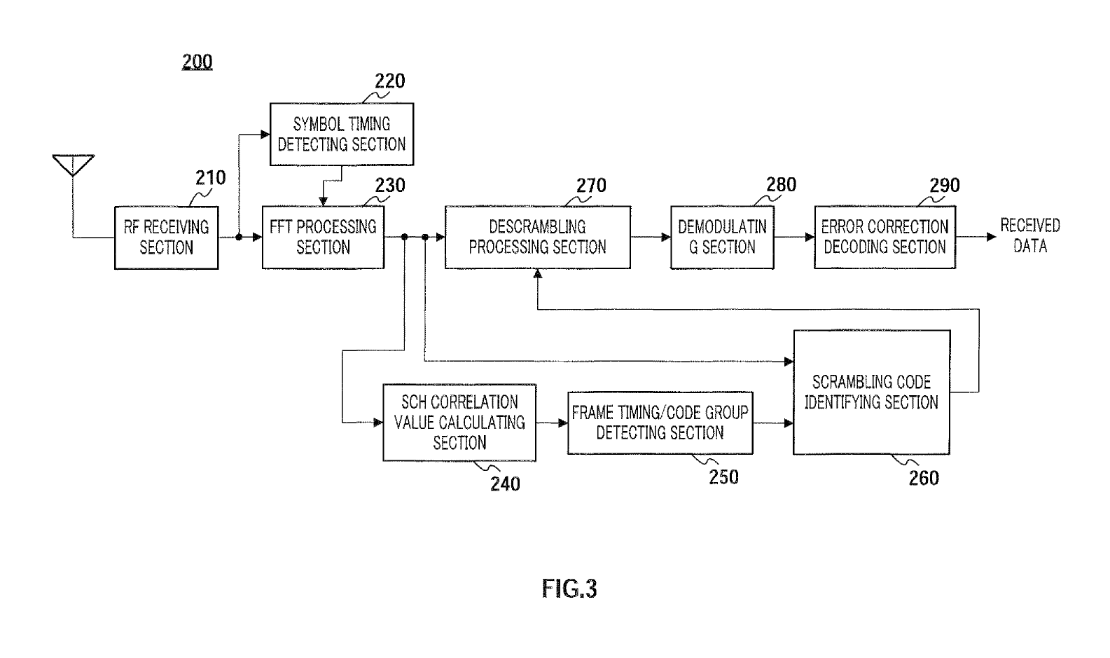

As shown in FIG. 3, mobile station apparatus 200 of Embodiment 1 has RF receiving section 210, symbol timing detecting section 220, FFT processing section 230, SCH correlation value calculating section 240, frame timing/code group detecting section 250, scrambling code identifying section 260, descrambling processing section 270, demodulating section 280 and error correction decoding section 290.

RF receiving section 210 receives a multicarrier signal transmitted from base station apparatus 100 via the antenna and performs predetermined radio receiving processing (such as down-conversion and A/D conversion) on the received signal.

Symbol timing detecting section 220 detects the symbol timing from correlation characteristics of the guard interval included in the received signal (first step in cell search).

FFT processing section 230 removes the guard interval and performs FFT processing according to the symbol timing detected by symbol timing detecting section 220.

SCH correlation value calculating section 240 receives the signal after FFT processing and calculates the time domain correlation between the received signal and replicas of the SCH sequence with respect to the subcarriers where the SCH sequence is multiplexed (hereinafter “SCH subcarriers”). This correlation is calculated with respect to all possible code groups using the SCH sequence replicas corresponding to the code groups.

That is, SCH correlation value calculating section 240 calculates the time domain correlation between the subcarrier signals where the SCH sequence is multiplexed (hereinafter “SCH subcarrier signals”) and the SCH sequence replicas corresponding to all code group sequences. That is, correlation values of the SCH subcarrier signals are calculated per code group.

Frame timing/code group detecting section 250 performs power addition of the correlation values corresponding to a plurality of SCH subcarriers for each code group and detects the timing at which the greatest sum of correlation values (maximum sum of correlation values) is calculated, and the code group corresponding to the SCH sequence replica used to calculate the maximum sum of correlation values as the frame timing and the code group, respectively (second step in cell search).

Scrambling code identifying section 260 calculates the correlation between the CPICH signal extracted from the received signal according to the frame timing detected by frame timing/code group detecting section 250, and the CPICH replicas corresponding to all scrambling codes belonging to the identified code group, and identifies that the scrambling code corresponding to the CPICH replica for which the greatest correlation value is calculated is the base station scrambling code corresponding to the cell of base station apparatus 100 (third step in cell search).

Descrambling processing section 270 receives the signal after FFT processing from FFT processing section 230, descrambles the signal by multiplying the base station scrambling code identified by scrambling code identifying section 260, and outputs the descrambled signal to demodulating section 280.

Demodulating section 280 receives the descrambled signal, performs appropriate demodulating processing and outputs the demodulated signal to error correction decoding section 290.

Error correction decoding section 290 receives the demodulated signal, performs appropriate error correction decoding processing and outputs the signal after error correction decoding, as received data.

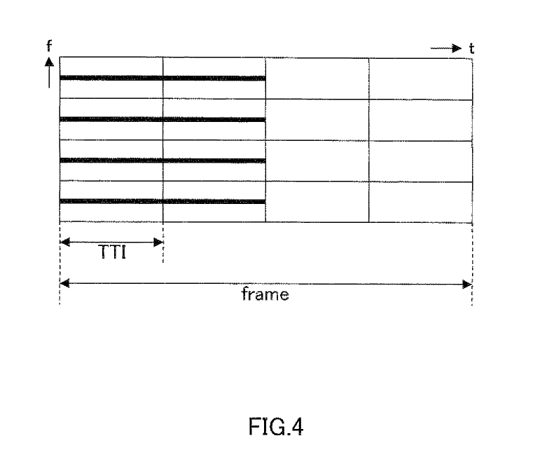

In the above description, a case has been described where the SCH sequence is the length of one frame, but this is by no means limiting, and, for example, the SCH sequence may be shorter than the length of one frame as shown in FIG. 4. Further, in FIG. 4, the length the SCH sequence is an integral multiple of the TTI unit, but the length of the SCH sequence does not always have to match the length of the TTI unit. It is only necessary to map the SCH sequence of the length of one frame or shorter at a position having a predetermined relationship with respect to the beginning of the frame (that is, frame timing) and identify the frame timing, and further, the code group based on the correlation values between the SCH sequence and SCH sequence replicas at the receiving side. When the SCH sequence is made shorter than the length of one frame, by mapping in one frame the TCH in a time period other than the time period where the SCH sequence is mapped, the SCH sequence and the TCH sequence can be mapped in the same frequency without overlapping with each other in the time domain, so that it is possible to prevent interference between the SCH sequence and the TCH sequence, improve received quality of the TCH sequence and increase the transmission amount of the TCH sequence. Further, when the SCH sequence is made shorter than the length of one frame, it is possible to reduce the calculation amount for calculating correlation values in mobile station apparatus 200 of the receiving side.

In this way, according to Embodiment base station apparatus 100 performs multicarrier transmission and has: frame forming section 120 that forms a frame by mapping transmission data (TCH sequence) and a sequence (SCH sequence) used to identify at the receiving side (mobile station apparatus 200) the frame timing and the code group to which the base station scrambling code belongs, such that the transmission data and the sequence do not overlap with each other in the same symbols specified by subcarriers and time; and RF transmitting section 150 that transmits the formed frame.

By this means, it is possible to prevent interference between the SCH sequence and the TCH sequence and improve received quality of the TCH sequence.

Frame forming section 120 maps the sequence (SCH sequence) on a plurality of predetermined subcarriers in the time domain and maps the transmission data (TCH sequence) on symbols other than the symbols where the sequence (SCH sequence) is mapped.

By this means, the SCH sequence and the TCH sequence can be mapped in the same frequency without overlapping with each other in the time domain, so that it is possible to prevent interference between the SCH sequence and the TCH sequence and improve received quality of the TCH sequence.

Frame forming section 120 makes the sequence (SCH sequence) shorter than the length of one frame, and maps the sequence (SCH sequence) so that the beginning of the sequence is aligned with the frame timing.

By this means, interference between the SCH sequence and the TCH sequence can be prevented, received quality of the TCH sequence can be improved, and the TCH sequence can be allocated to the part left by making the SCH sequence shorter than the length of one frame, so that it is possible to increase the transmission amount of the TCH sequence.

Further, according to Embodiment 1, mobile station apparatus 200 performs a cell search based on a frame transmitted from base station apparatus 100 and has: RF receiving section 210 that receives a frame where transmission data (TCH sequence) and a sequence (SCH sequence) are mapped such that the transmission data and the sequence do not overlap with each other in the same symbols specified by subcarriers and time, the sequence being used to identify the frame timing and the code group to which the base station scrambling code belongs; SCH correlation value calculating section 240 that calculates correlations by sequentially multiplying the frame by all candidates of the sequence (SCH sequence); and frame timing/code group detecting section 250 that detects the frame timing and the code group based on the correlation values calculated by SCH correlation value calculating section 240.

By this means, it is possible to prevent interference between the SCH sequence and the TCH sequence and improve received quality of the TCH sequence.

### Embodiment 2

It is a feature of this embodiment to insert two different SCH sequences (SCH 1 and SCH 2) for frame timing detection use and for code group identification use to a frame, and transmit the frame.

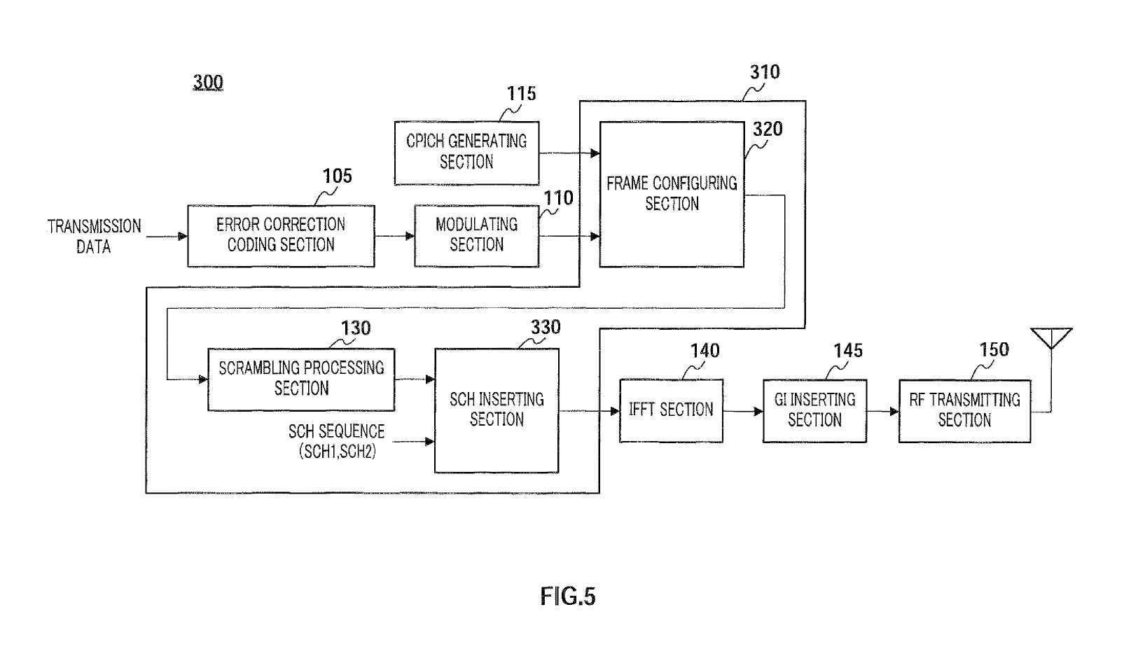

As shown in FIG. 5, base station apparatus 300 of Embodiment 2 has frame forming section 310. This frame forming section 310 has frame configuring section 320 and SCH inserting section 330.

Frame configuring section 320 receives and maps a CPICH symbol and the modulated signal at predetermined positions in the frequency domain and the time domain taking into consideration the positions in the frame where two different SCH sequences (SCH1 and SCH2) are inserted by SCH inserting section 330. The frame configured in this way by frame configuring section 320 is inputted to scrambling processing section 130.

SCH inserting section 330 inserts the two different SCH sequences (SCH1 and SCH2) to the frame multiplied by the base station scrambling code by scrambling processing section 130. In this embodiment, over a plurality of predetermined subcarriers, that is, predetermined positions in the frequency domain, two frequency-multiplexed, and the frequency-multiplexed SCH sequences are inserted to the frame after scrambling processing.

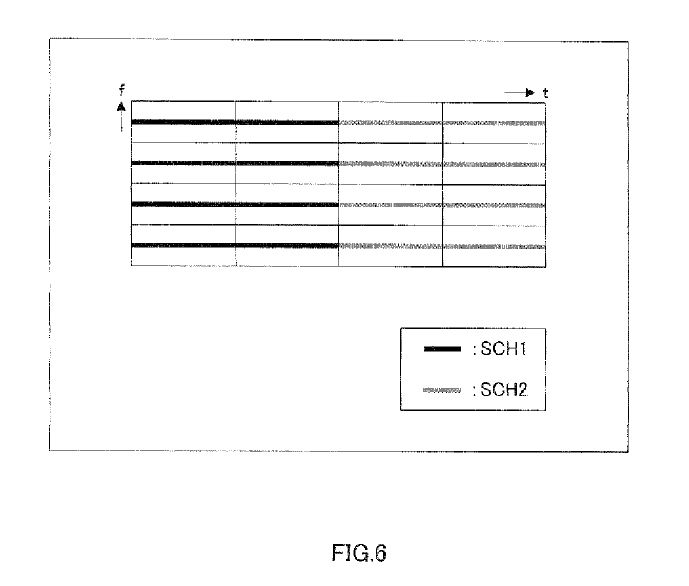

The frame formed as described above by frame forming section 310 has the configuration shown in FIG. 6. That is, in this frame configuration, the SCH sequence is mapped on a plurality of predetermined subcarriers in the time domain, the TCH (Traffic CHannel) is mapped on other subcarriers, and the SCH sequence and the TCH sequence do not overlap with each other in the frequency domain. Further, with respect to the subcarriers to which the SCH sequence is inserted, one frame is divided into two time regions, and two different SCH sequences (SCH1 and SCH2) are mapped in these time regions, respectively.

As SCH2 out of the two different SCH sequences, a code group sequence, which is a code group that groups the base station scrambling codes, is used. SCH1 is used to detect the frame timing, and SCH2 is used to identify the code group. Further, the length of SCH1 and SCH2 corresponds to half the length of one frame. SCH1 is mapped in the time region of the first half of the frame in synchronization with the frame timing, SCH2 is mapped in the time region of the second half of the frame so that the beginning of the time region is aligned with the ending of SCH1 and the ending of SCH2 is aligned with the ending of the frame. By adopting such a frame configuration, interference between the SCH sequence and the TCH sequence can be prevented, so that it is possible to improve received quality of the TCH in this frame at the receiving side.

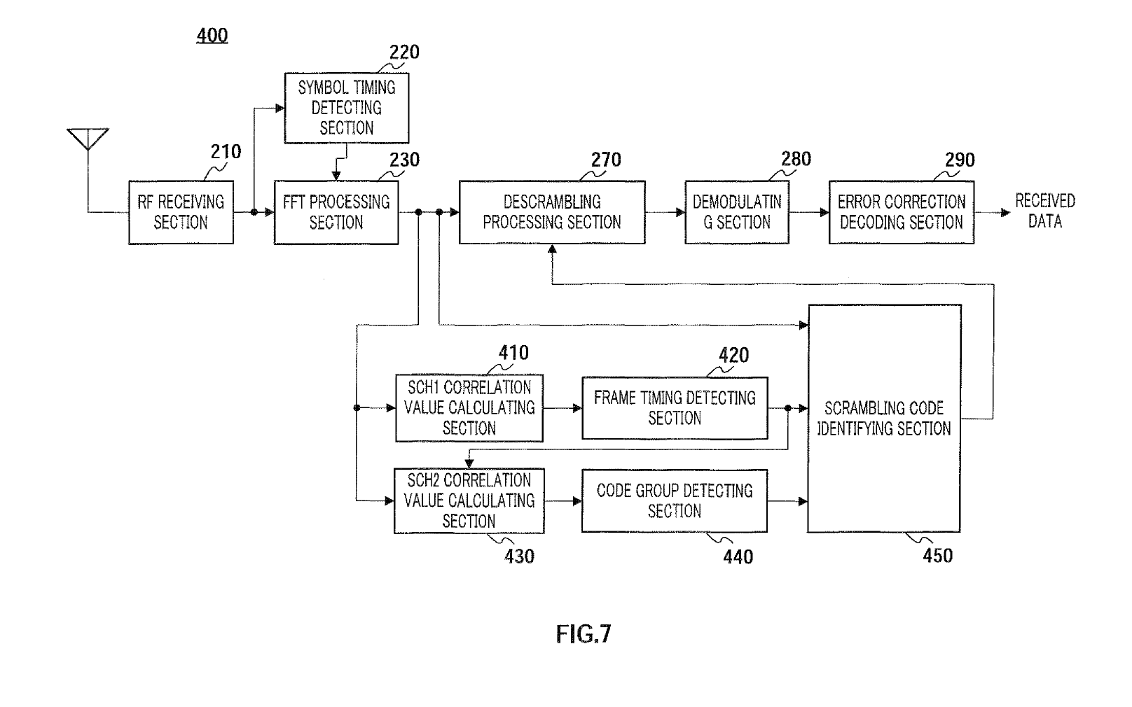

As shown in FIG. 7, mobile station apparatus 400 of Embodiment 2 has SCSI correlation value calculating section 410, frame timing detecting section 420, SCH2 correlation value calculating section 430, code group identifying section 440 and scrambling code identifying section 450.

SCH1 correlation value calculating section 410 receives the received signal after FFT processing and calculates the time domain correlation between the received signal and SCH1 sequence replicas with respect to the SCH1 subcarriers where SCH1 is multiplexed. In the above frame configuration, that is, in a configuration where the SCH1 is half the length of one frame, it is only necessary to calculate the time domain correlation with respect to the half frame, so that it is possible to reduce the calculation amount compared to Embodiment 1.

Frame timing detecting section 420 performs power addition of correlation values corresponding to a plurality of SCH1 subcarriers and detects the timing at which the greatest sum of correlation values (maximum sum of correlation values) is calculated as a frame timing. Frame timing detecting section 420 outputs frame timing information to SCH2 correlation value calculating section 430.

SCH2 correlation value calculating section 430 receives the received signal after FFT processing and calculates correlations between the received signal and SCH2 sequence replicas in accordance with a frame timing shown in the frame timing information from frame timing detecting section 420. When the frame timing is detected, the position (arrangement) of the SCH2 sequence in the frame is determined, so that the correlation calculation processing amount can be reduced. This correlation is calculated with respect to all possible code groups using the SCH2 sequence replicas corresponding to the code groups.

That is, SCH2 correlation value calculating section 430 calculates correlation between the subcarrier signals where the SCH2 sequence is multiplexed (hereinafter “SCH2 subcarrier signals”) and the SCH2 sequence replicas corresponding to all code group sequences based on the frame timing. That is, correlation values of the SCH2 subcarrier signals are calculated per code group, based on the frame timing.

Code group detecting section 440 performs power addition of the correlation values corresponding to a plurality of SCH2 subcarriers for each code group and detects the code group corresponding to the SCH2 sequence replica used to calculate the maximum sum of correlation values as a code group.

Scrambling code identifying section 450 calculates correlation between the CPICH signal which is extracted from the received signal in accordance with the frame timing detected by frame timing detecting section 420, and the CPICH replicas corresponding to all scrambling codes belonging to the identified code group, and identifies that the scrambling code corresponding to the CPICH replica for which the greatest correlation value is calculated is the base station scrambling code corresponding to the cell of base station apparatus 300 (third step in cell search).

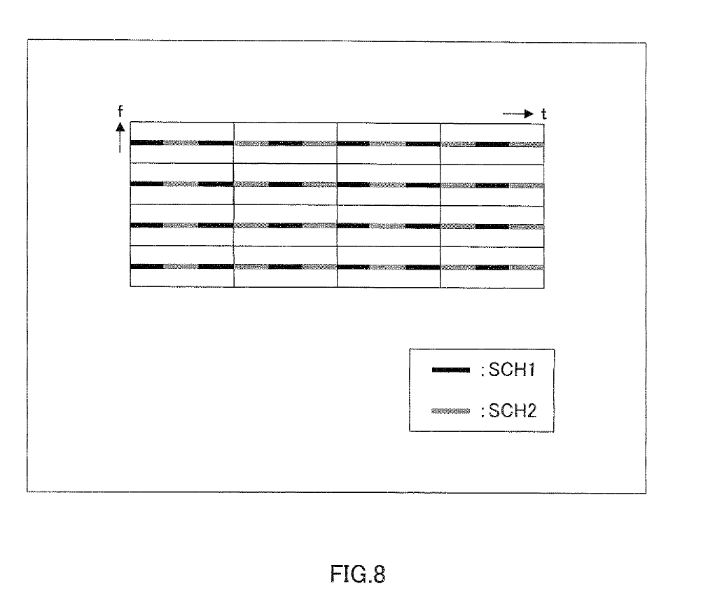

In the above description, the SCH1 sequence and SCH2 are half the length of one frame, but this is by no means limiting, and, for example, the SCH1 sequence and SCH2 may be shorter than half the length of one frame as shown in FIG. 8. Further, FIG. 6 and FIG. 8 show frame configurations where SCH1 subcarriers and SCH2 subcarriers are identical, but SCH1 subcarriers may be different from SCH2 subcarriers. The relationship between positions in the time domain where SCH1 and SCH2 are mapped is arbitrary.

It is only necessary to map an SCH1 sequence of half the length of one frame or shorter at a position having a predetermined positional relationship with respect to the beginning of the frame (that is, frame timing), identify the frame timing at the receiving side based on the correlation values between this SCH1 sequence and SCH1 sequence replicas, and, further, map an SCH2 sequence of half the length of one frame or shorter at a posit ion having a predetermined positional relationship with respect to the beginning of the frame (that is, frame timing), and identify the code group at the receiving side based on the correlation values between this SCH2 sequence and SCH2 sequence replicas.

In this way, according to Embodiment 2, base station apparatus 300 performs multicarrier transmission and has: frame forming section 310 that forms a frame by mapping transmission data (TCH sequence) and a sequence (SCH sequence) used to identify at the receiving side (mobile station apparatus 400) the frame timing and the code group to which the base station scrambling code belongs, such that the transmission data and the sequence do not overlap with each other in the same symbols specified by subcarriers and time; and RF transmitting section 150 that transmits the formed frame. This frame forming section 310 makes the a first sequence (SCH1 sequence) for identifying the frame timing and a second sequence (SCH2 sequence) for identifying the code group shorter than half the length of one frame, the second sequence being different from the first sequence, and maps the first sequence and the second sequence at predetermined positions from the beginning of the frame. In Embodiment 2, frame forming section 310 particularly maps the first sequence and the second sequence such that the beginning of the first sequence is aligned with the beginning of the frame and the ending of the second sequence is aligned with the ending of the frame.

By this means, it is possible to prevent interference between the SCH sequence and the TCH sequence and improve received quality of the TCH sequence. Further, by making the first sequence (SCH1 sequence) shorter than half the length of one frame, it is possible to reduce the calculation amount for calculating correlation values at mobile station apparatus 400 of the receiving side compared to conventional cases where the SCH sequence is mapped over one frame. Further, after the frame timing is detected using the first sequence (SCH1 sequence) at mobile station apparatus 400 of the receiving side, the position (arrangement) of the second sequence (SCH2 sequence) in the frame is determined, so that it is possible to reduce the processing amount for correlation calculation. Further, it is not necessary to perform the frame timing detection and the code group detection at the same time, so that it is possible to reduce the processing amount per unit time.

Further, according to Embodiment 2, mobile station apparatus 400 performs a cell search based on a frame transmitted from base station apparatus 300 and has: RF receiving section 210 that receives a frame where a first sequence (SCH1 sequence) for identifying the frame timing and a second sequence (SCH2 sequence) for identifying the code group are made shorter than half the length of one frame, the second sequence being different from the first sequence, and the first sequence and the second sequence are mapped in the time domain so that the beginning of the first sequence is aligned with the beginning of the frame and the ending of the second sequence is aligned with the ending of the frame; SCH1 correlation value calculating section 410 that calculates correlations by sequentially multiplying the frame by all candidates of the first sequence in the time domain; SCH2 correlation value calculating section 430 that calculates correlations by sequentially multiplying the frame by all candidates of the second sequence in the time domain; and frame timing detecting section 420 that detects the frame timing based on the correlation values calculated by SCH1 correlation value calculating section 410; and code group detecting section 440 that detects the code group based on the correlation values calculated by SCH2 correlation value calculating section 430, SCH2 correlation value calculating section 430 sequentially multiplies a position in the frame where the second sequence is mapped by all candidates of the second sequence based on the frame timing detected by frame timing detecting section 420.

By this means, it is possible to prevent interference between the SCH sequence and the TCH sequence and improve received quality of the TCH sequence. Furthermore, by making the first sequence (SCH1 sequence) shorter than half the length of one frame, it is possible to reduce the calculation amount for calculating correlation values at mobile station apparatus 400 compared to conventional cases where the SCH sequence is mapped over one frame. Further, after the frame timing is detected using the first sequence (SCH1 sequence) at mobile station apparatus 400, the position (arrangement) of the second sequence (SCH2 sequence) in the frame is determined, so that it is possible to reduce the processing amount for correlation calculation. Still further, it is not necessary to perform the frame timing detection and the code group identification at the same time, so that it is possible to reduce the processing amount per unit time.

### Embodiment 3

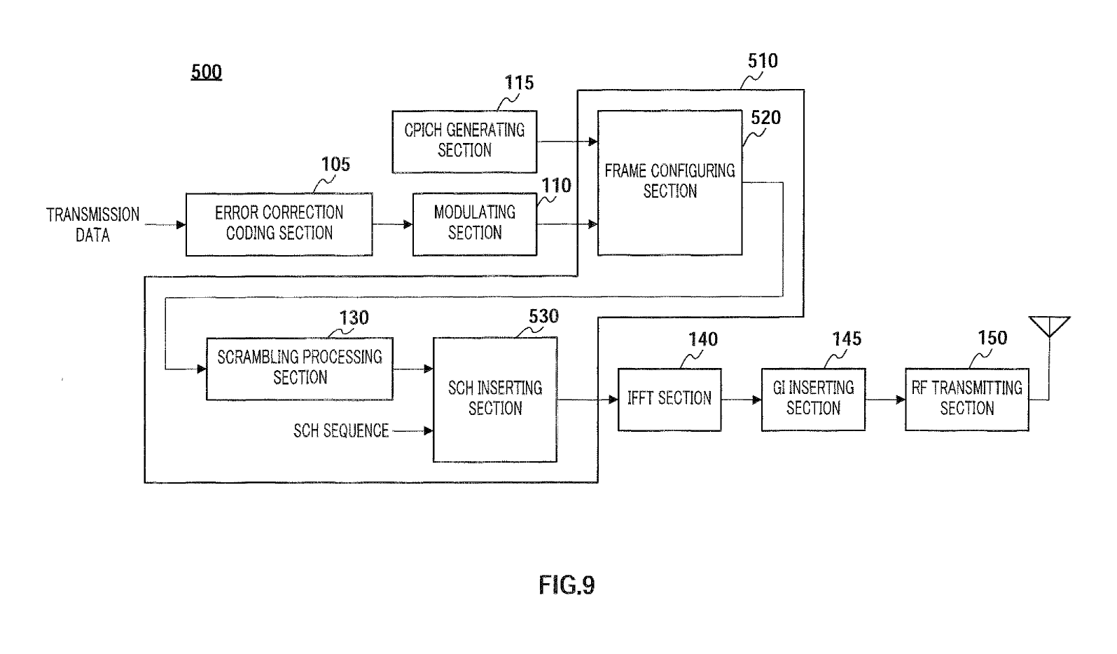

It is a feature of this embodiment that the base station apparatus inserts an SCH sequence to the whole or part of the OFDM symbol at a predetermined position from the beginning of the frame and transmits the frame. As shown in FIG. 9, base station apparatus 500 of Embodiment 3 has frame forming section 510. This frame forming section 510 has frame configuring section 520 and SCH inserting section 530.

Frame configuring section 520 receives and maps a CPICH symbol and the modulated signal at predetermined positions in the frequency domain and the time domain taking into consideration the position in the frame where the SCH sequence is inserted by SCH inserting section 530. The frame configured in this way by frame configuring section 520 is inputted to scrambling processing section 130.

Scrambling processing section 130 multiplies the frame formed by frame configuring section 520 by a base station scrambling code which is unique to base station apparatus 500. This base station scrambling code is used to identify the cell (or sectors) covered by base station apparatus 500.

SCH inserting section 530 inserts an SCH sequence as a synchronization code to the frame multiplied by the base station scrambling code at scrambling processing section 130. In this embodiment, the SCH sequence is time-multiplexed over a predetermined OFDM symbol, that is, a specific symbol timing in all subcarriers, and the time-multiplexed SCH sequence is inserted to the frame after scrambling processing. A code group sequence, which is a code group that groups base station scrambling codes, is used as the SCH sequence.

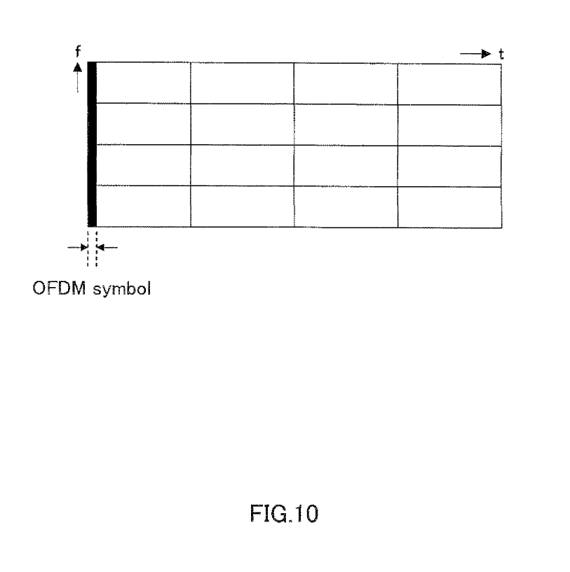

The frame formed as described above by frame forming section 510 adopts the configuration shown in FIG. 10. That is, in this frame configuration, the SCH sequence is mapped on the predetermined OFDM symbol in the frame in the frequency domain and a TCH (Traffic CHannel) is mapped on other OFDM symbols, and the SCH sequence and the TCH sequence do not overlap with each other in the time domain. By adopting such a frame configuration, interference between the SCH sequence and the TCH sequence can be prevented, so that it is possible to improve received quality of the TCH in this frame at the receiving side.

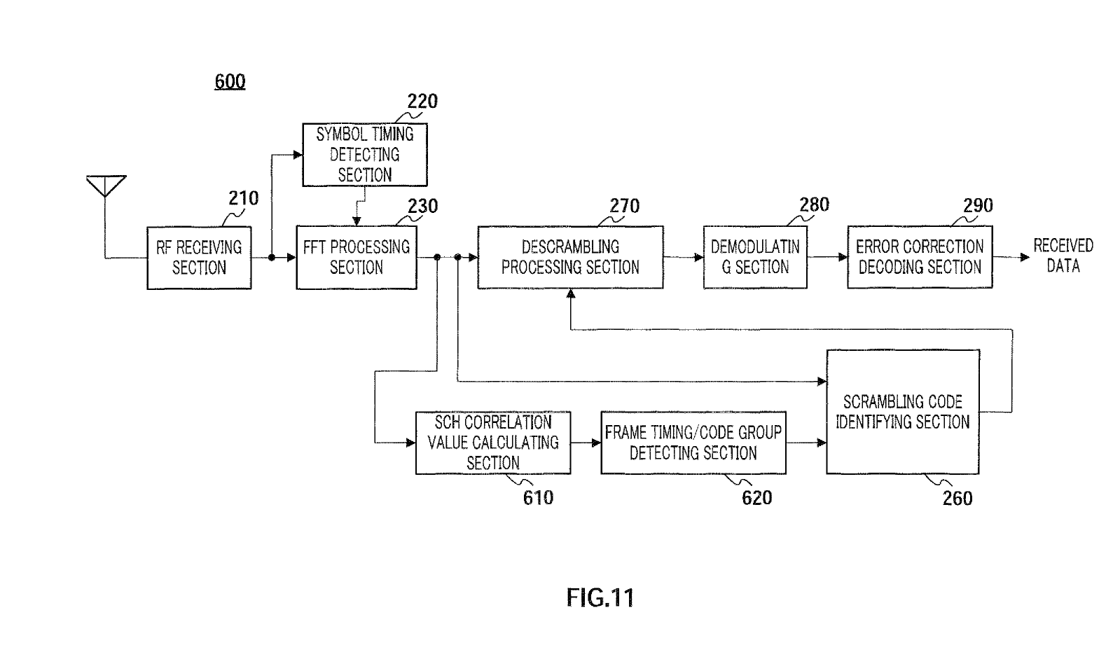

As shown in FIG. 11, mobile station apparatus 600 of Embodiment 3 has SCH correlation value calculating section 610 and frame timing/code group detecting section 620.

SCH correlation value calculating section 610 calculates the frequency domain correlation between the OFDM symbols and SCH sequence replicas with respect to all OFDM symbols in one frame. This correlation is calculated with respect to all possible code groups using the SCH sequence replicas corresponding to the code groups. That is, correlation values of the OFDM symbols are calculated per code group.

Frame timing/code group detecting section 620 detects, out of the correlation values of the OFDM symbols for each code group calculated by SCH correlation value calculating section 610, the timing at which the greatest correlation value (maximum correlation value) is calculated and the code group corresponding to the SCH sequence replica used to calculate the maximum sum of correlation values as the frame timing and the code group, respectively.

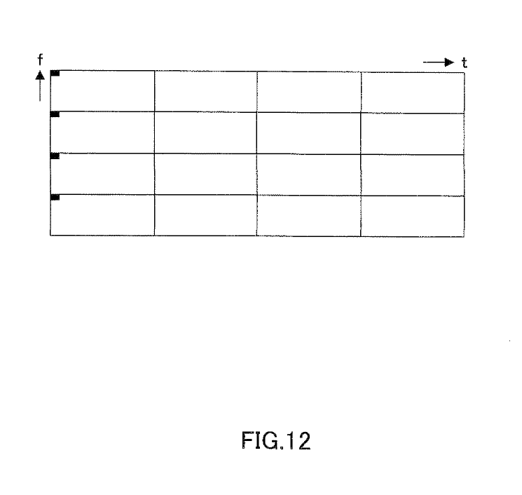

In the above description, a frame configuration has been described where the SCH sequence is time-multiplexed over a predetermined OFDM symbol, that is, a specific symbol timing for all subcarriers, and the time-multiplexed SCH sequence is inserted to the frame after scrambling processing. However, this is by no means limiting, and, for example, as shown in FIG. 12, it is also possible to time-multiplex the SCH sequence with part of the symbols in a predetermined OFDM symbol, that is, over the symbols corresponding to part of the subcarriers in the OFDM symbol, and inserts the symbols to the frame. It is only necessary to map the SCH sequence over the whole or part of the OFDM symbol at a predetermined position from the beginning of the frame and identify the frame timing and the code group based on the correlation values between the SCH sequence and the SCH sequence replicas at the receiving side.

In this way, according to Embodiment 3, base station apparatus 500 performs multicarrier transmission and has: frame forming section 510 that forms a frame by mapping transmission data (TCH sequence) and a sequence (SCH sequence) used to identify the frame timing and the code group to which a base station scrambling code belongs at the receiving side (mobile station apparatus 600), such that the transmission data and the sequence do not overlap with each other in the same symbols specified by subcarriers and time; and RF transmitting section 150 that transmits the formed frame. This frame forming section 510 maps the sequence (SCH sequence) on the whole or part of the OFDM symbol in the frequency domain and maps the transmission data (TCH sequence) on symbols other than the symbols where the sequence (SCH sequence) is mapped.

By this means, the SCH sequence and the TCH sequence can be mapped in the same frequency without overlapping with each other in the time domain, so that it is possible to prevent interference between the SCH sequence and the TCH sequence and improve received quality of the TCH sequence.

### Embodiment 4

It is a feature of this embodiment that the base station apparatus inserts two different SCH sequences (SCH1 and SCH2) for frame timing detection use and for code group identification use to the whole or part of the OFDM symbol at a predetermined position from the beginning of the frame and transmits the OFDM symbol.

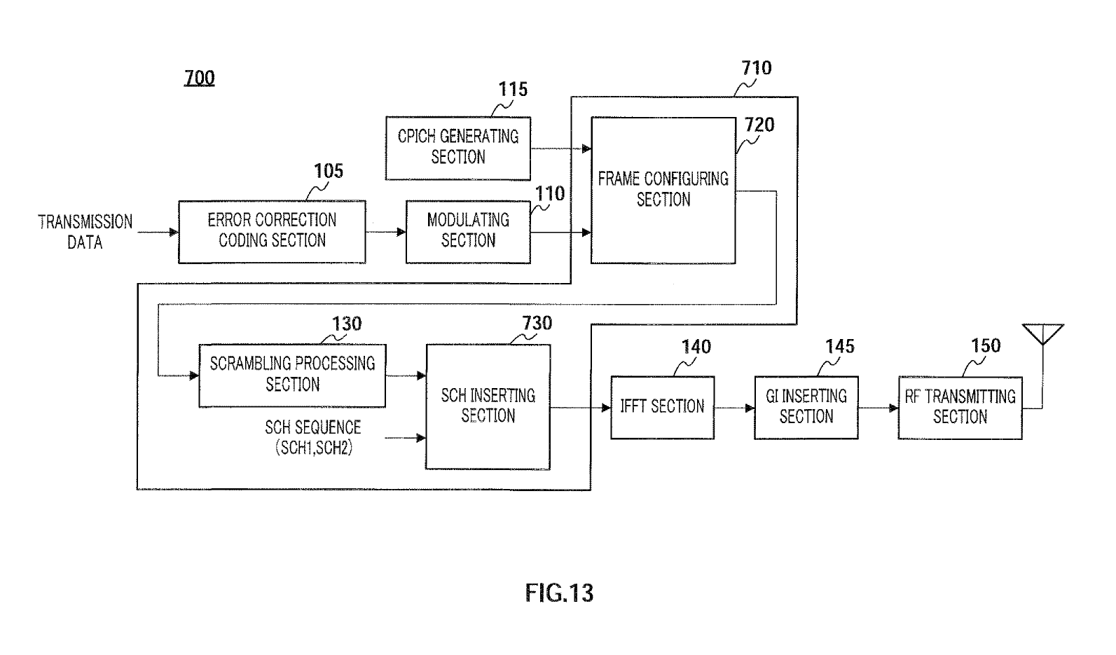

As shown in FIG. 13, base station apparatus 700 of Embodiment 4 has frame forming section 710. This frame forming section 710 has frame configuring section 720 and SCH inserting section 730.

Frame configuring section 720 receives and maps a CPICH symbol and the modulated signal at predetermined positions in the frequency domain and the time domain taking into consideration the positions in the frame where the two different SCH sequences (SCH1 and SCH2) are inserted by SCH inserting section 730. The frame configured in this way by frame configuring section 720 is inputted to scrambling processing section 130.

SCH inserting section 730 inserts two different SCH sequences (SCH1 and SCH2) to the frame multiplied by the base station scrambling code by scrambling processing section 130. In this embodiment, the two different SCH sequences (SCH1 and SCH2) are time-multiplexed over the predetermined OFDM symbol, that is, a specific symbol timing in all subcarriers, and the time-multiplexed SCH sequences are inserted to the frame after scrambling processing.

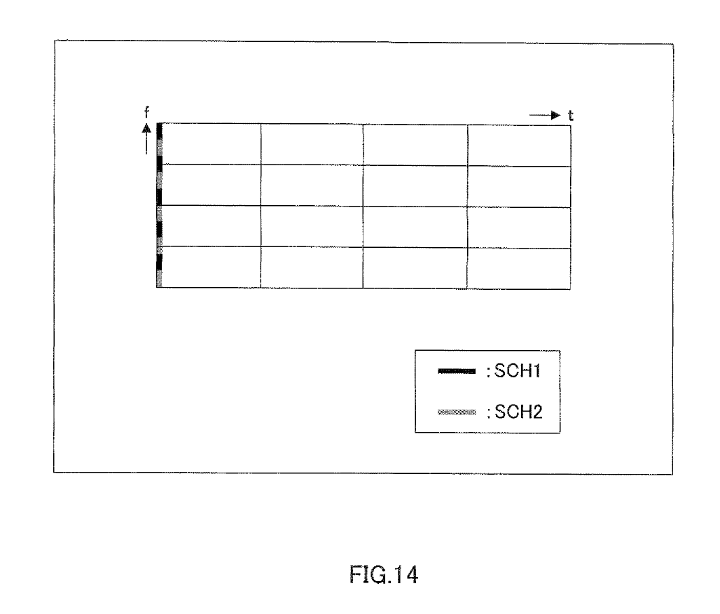

The frame formed as described above by frame forming section 710 adopts the configuration shown in FIG. 14. That is, in this frame configuration, the two different SCH sequences (SCH1 and SCH2) are mapped on the predetermined OFDM symbol in the frame in the frequency domain, TCH is mapped on other OFDM symbols, and the SCH sequences and the TCH sequences do not overlap with each other in the frequency domain. By adopting such a frame configuration, interference between the SCH sequence and the TCH sequence can be prevented, so that it is possible to improve received quality of the TCH in this frame at the receiving side. Particularly, in FIG. 14, the SCH1 sequences and the SCH2 sequences are alternately mapped on subcarriers of the OFDM symbol.

A code group sequence, which is a code group that groups base station scrambling codes, is used as SCH2 out of the two different SCH sequences. SCH1 is used to detect the frame timing, and SCH2 is used to identify the code group.

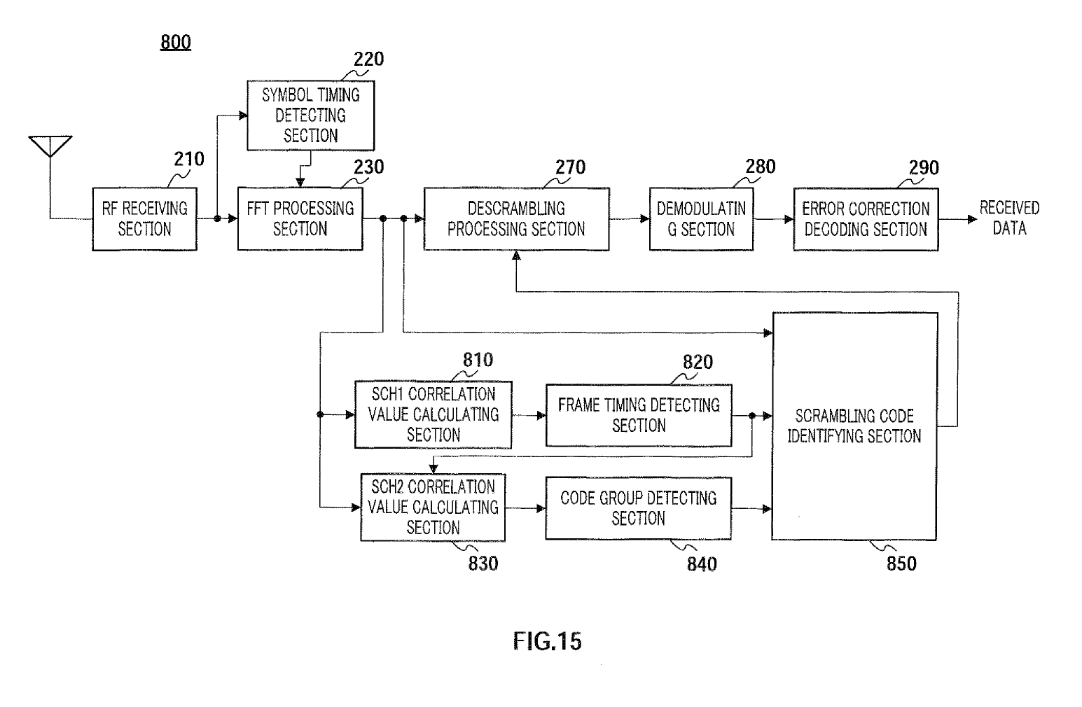

As shown in FIG. 15, mobile station apparatus 800 of Embodiment 4 has SCH1 correlation value calculating section 810, frame timing detecting section 820, SCH2 correlation value calculating section 830, code group detecting section 840 and scrambling code identifying section 850.

SCH1 correlation value calculating section 810 receives the signal after FFT processing and calculates the frequency domain correlation between the received signal and the SCH1 sequence replicas with respect to the subcarriers where the SCH1 sequence is multiplexed, for all OFDM symbols in one frame. In the above frame configuration, that is, in a configuration where the SCH1 sequence is mapped on part of the OFDM symbol, it is only necessary to calculate the frequency domain correlation with respect to part of the subcarriers, so that it is possible to reduce the calculation amount compared to Embodiment 3.

Frame timing detecting section 820 performs power addition of the correlation values calculated by SCH1 correlation value calculating section 810 per OFDM symbol and detects the timing at which the greatest sum of correlation values (maximum sum of correlation values) is calculated as the frame timing. Frame timing detecting section 820 outputs frame timing information to SCH2 correlation value calculating section 830.

SCH2 correlation value calculating section 830 receives the signal after FFT processing and calculates the frequency domain correlation between the received signal and SCH2 sequence replicas with respect to the subcarriers where the SCH2 sequence is multiplexed, based on a frame timing shown in the frame timing information from frame timing detecting section 820. If a frame timing is detected, the position of the SCH2 sequence in the frame is determined (that is, specified by time and frequency), so that it is possible to reduce the processing amount for correlation calculation. This correlation is calculated with respect to all possible code groups using the SCH2 sequence replicas corresponding to the code groups.

Code group detecting section 840 performs power addition of the correlation values calculated by SCH2 correlation value calculating section 830 and detects the code group corresponding to the SCH2 sequence replica used to calculate the maximum sum of correlation values as the code group.

Scrambling code identifying section 850 calculates correlation between the CPICH signal which is extracted from the received signal in accordance with the frame timing detected by frame timing detecting section 820, and the CPICH replicas corresponding to all scrambling codes belonging to the identified code group, and identifies that the scrambling code corresponding to the CPICH replica for which the greatest correlation value is calculated is the base station scrambling code corresponding to the cell of base station apparatus 700 (third step in cell search).

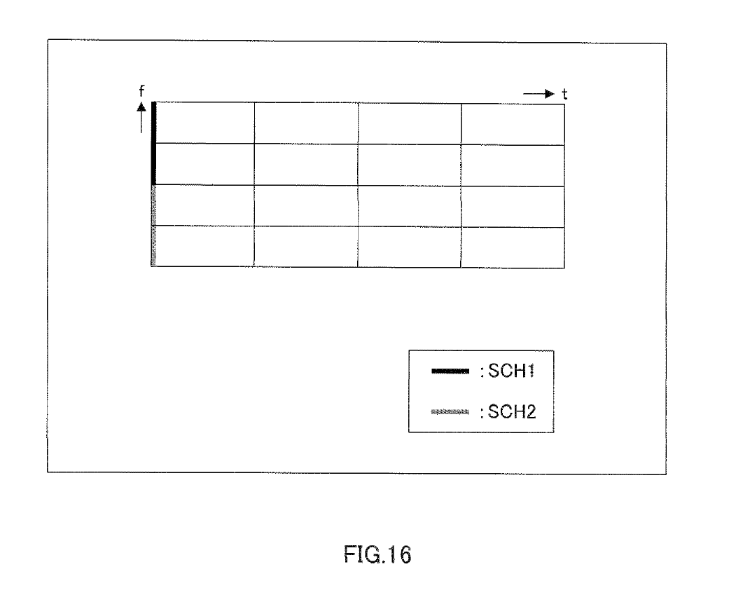

In the above description, a frame configuration has been described where the SCH1 sequence and the SCH2 sequence are alternately mapped on subcarriers of the same OFDM symbol. However, this is by no means limiting, and, for example, as shown in FIG. 16, a frame configuration is also possible where the SCH1 sequence and the SCH2 sequence are mapped per subcarrier block comprised of a plurality of subcarriers of the same OFDM symbol. Further, the SCH1 sequence and the SCH2 sequence do not need to be mapped on the same OFDM symbol. Still further, the positional relationship between the SCH1 sequence and the SCH2 sequence in the frequency domain is arbitrary. It is only necessary to map the SCH1 sequence in part of the OFDM symbol at a predetermined position from the beginning of the frame, identify the frame timing based on the frequency domain correlation values between the SCH1 sequence and the SCH sequence replicas at the receiving side, map the SCH2 sequence on subcarriers which are part of the OFDM symbol at a predetermined position from the beginning of the frame and where the SCH1 sequence is not mapped, and identify the code group based on the frequency domain correlation values between the SCH2 sequence and SCH sequence replicas at the receiving side.

In this way, according to Embodiment 4, base station apparatus 700 has: frame forming section 710 that forms a frame by mapping transmission data (TCH sequences) and a sequence (SCH sequence) used to identify the frame timing and the code group to which the base station scrambling code belongs at the receiving side (mobile station apparatus 800), such that the transmission data and the sequence do not overlap with each other in the same symbols specified by subcarriers and time; and RE transmitting section 150 that transmits the formed frame. This frame forming section 710 maps a first sequence for identifying the frame timing on part of the OFDM symbol and maps a second sequence for identifying the code group, which is different from the first sequence, on other symbols than the part of the OFDM symbol where the first sequence is mapped.

By this means, the SCH sequence and the TCH sequence can be mapped in the same frequency without overlapping with each other in the time domain, so that it is possible to prevent interference between the SCH sequence and the TCH sequence and improve the received quality of the TCH sequence.

Further, according to Embodiment 4, mobile station apparatus 800 performs a cell search based on the frame timing transmitted from base station apparatus 700 and has: RF receiving section 210 that receives a frame where the first sequence (SCH1 sequence) for identifying the frame timing is mapped on part of the OFDM symbol in the frequency domain and the second sequence (SCH2 sequence) for identifying the code group, which is different from the first sequence, is mapped on the frequency domain in other symbols than the part of the OFDM symbol where the first sequence is mapped; SCH1 correlation value calculating section 810 that calculates correlations by sequentially multiplying in the frequency domain the frame by all candidates of the first sequence; SCH2 correlation value calculating section 830 that calculates correlations by sequentially multiplying in the frequency domain the frame by all candidates of the second sequence; frame timing detecting section 820 that detects the frame timing based on the correlation values calculated by SCH1 correlation value calculating section 810; code group detecting section 840 that detects the code group based on the correlation values calculated by SCH2 correlation value calculating section 830. SCH2 correlation value calculating section 830 sequentially multiplies the position in the frame where the second sequence is mapped by all candidates of the second sequence based on the frame timing detected by frame timing detecting section 820.

By this means, it is possible to prevent interference between the SCH sequence and the TCH sequence and improve received quality of the TCH sequence. Further, after the frame timing is detected by mobile station apparatus 800 using the first sequence (SCH1 sequence), the position (arrangement) of the second sequence (SCH2 sequence) in the frame is determined, so that it, is possible to reduce the processing amount for correlation calculation. Further, it is not necessary to perform the frame timing detection and the code group detection at the same time, so that it is possible to reduce the processing amount per unit time.

### INDUSTRIAL APPLICABILITY

The base station apparatus and the mobile station apparatus of the present invention perform multicarrier communication and are suitable for preventing interference between a sequence for acquiring synchronization and transmission data, and improving received quality of transmission data at the mobile station.

1. A base station apparatus that performs multicarrier transmission, comprising:
a frame forming section that forms a frame by mapping transmission data and a sequence used to identify a frame timing and a code group to which a base station scrambling code belongs, such that the transmission data and the sequence do not overlap with each other in same symbols specified by subcarriers and time; and
a transmitting section that transmits the formed frame.

2. The base station apparatus according to claim 1, wherein the frame forming section maps the sequence on a plurality of predetermined subcarriers in a time domain and maps the transmission data on other symbols than symbols where the sequence is mapped.

3. The base station apparatus according to claim 2, wherein the frame forming section makes a length of the sequence shorter than one frame and maps the sequence so that a beginning of the sequence is aligned with the frame timing.

4. The base station apparatus according to claim 1, wherein the frame forming section makes a first sequence for identifying the frame timing and a second sequence for identifying the code group shorter than half the length of one frame, said second sequence being different from the first sequence, and maps the first sequence and the second sequence so that a beginning of the first sequence is aligned with a beginning of the frame and an ending of the second sequence is aligned with an ending of the frame.

5. The base station apparatus according to claim 1, wherein the frame forming section maps the sequence on all or part of symbols of an orthogonal frequency division multiplexing symbol in a frequency domain and maps the transmission data on other symbols than the symbols where the sequence is mapped.

6. The base station apparatus according to claim 5, wherein the frame forming section maps a first sequence for identifying the frame timing on part of symbols of the OFDM symbol and maps a second sequence for identifying the code group on other symbols than the part of the symbols where the first sequence is mapped, said second sequence being different from the first sequence.

7. A mobile station apparatus that performs a cell search based on a frame transmitted from a base station apparatus, the mobile station apparatus comprising:
a receiving section that receives a frame where transmission data and a sequence are mapped such that the transmission data and the sequence do not overlap with each other in same symbols specified by subcarriers and time, said sequence being used to identify a frame timing and a code group to which a base station scrambling code belongs;
a correlating section that calculates correlations by sequentially multiplying the frame by all candidates of the sequence; and
a detecting section that detects the frame timing and the code group based on the correlation values calculated by the correlating section.

8. The mobile station apparatus according to claim 7, wherein:
the receiving section receives a frame where a first sequence for identifying the frame timing and a second sequence for identifying the code group are both made shorter than half the length of one frame, said second sequence being different from the first sequence, and the first sequence and the second sequence are mapped in a time domain so that a beginning of the first sequence is aligned with a beginning of a frame and an ending of the second sequence is aligned with an ending of the frame;
the correlating section comprises:
a first correlating section that calculates correlations by sequentially multiplying in the time domain the frame by all candidates of the first sequence; and
a second correlating section that calculates correlations by sequentially multiplying in the time domain the frame by all candidates of the second sequence;
the detecting section comprises:
a frame timing detecting section that detects the frame timing based on the correlation values calculated by the first correlating section; and
a code group detecting section that detects the code group based on the correlation values calculated by the second correlating section; and
the second correlating section sequentially multiplies a position in the frame where the second sequence is mapped by all candidates of the second sequence based on the frame timing detected by the frame timing detecting section.

9. The mobile station apparatus according to claim 7, wherein:
the receiving section receives a frame where a first sequence for identifying the frame timing is mapped on part of symbols of an orthogonal frequency division multiplexing symbol in a frequency domain and a second sequence for identifying the code group is mapped in the frequency domain on other symbols than the part of the symbols where the first sequence is mapped, said second sequence being different from the first sequence;
the correlating section comprises:
a first correlating section that calculates correlations by sequentially multiplying the frame by all candidates of the first sequence in the frequency domain; and
a second correlating section that calculates correlations by sequentially multiplying the frame by all candidates of the second sequence in the frequency domain;
the detecting section comprises:
a frame timing detecting section that detects the frame timing based on the correlation values calculated by the first correlating section; and
a code group detecting section that detects the code group based on the correlation values calculated by the second correlating section; and
the second correlating section sequentially multiplies a position in the frame where the second sequence is mapped by all candidates of the second sequence based on the frame timing detected by the frame timing detecting section.
